(19) United States
(12) Patent Application Publication
(10) Pub. No.: US 2013/0073600 A1
(43) Pub. Date: Mar. 21, 2013

(54) REMOTE PROCESS EXECUTION MANAGEMENT

(71) Applicants: Jonathan A. Jenkins, Seattle, WA (US); Brett R. Taylor, Bainbridge Island, WA (US)

(72) Inventors: Jonathan A. Jenkins, Seattle, WA (US); Brett R. Taylor, Bainbridge Island, WA (US)

(21) Appl. No.: 13/239,187

(22) Filed: Sep. 21, 2011

(51) Int. Cl. G06F 15/16

(52) U.S. Cl. 709/201

(57) ABSTRACT

A remote execution management process is directed to the execution and management of aspects of a software process instance at a network computing provider. A client computing device may instantiate a software process instance. The client computing device determines a remote process configuration for the software process instance, including identifying at least one sub-process of the software process instance for execution at the network computing provider. The client computing device may provide the remote session configuration information to the network computing provider. Based on the remote session configuration information, the network computing provider may instantiate a remote session corresponding to the at least one sub-process. The network computing provider may transmit processing results back to the client computing device associated with execution of the least one sub-process by the remote session.

### BACKGROUND

Generally described, computing devices execute processes consisting of a number of computer-readable instructions causing the computing device to perform a wide variety of functions or actions. Typically, an operating system manages many of the basic functions or functionality, often referred to as “low level operation” associated with a computing device. In one aspect, the management of basic functionality can include the management of resources associated with the computing device, such as device memory, data storage, and inputs/outputs. In another aspect, the management of basic functionality can include the management of instructions associated with one or more software applications instantiated and requesting execution of instructions, typically referred to as processes or threads, on the computing device. For example, the operating system may determine an allocation of device resources and order of execution among various applications, services, and other processes instantiated on the device.

In some cases, the resource requirements of processes executing on the computing device may exceed the capabilities of the available computing device resources. In such situations, a user may experience a delay or lack of responsiveness. With reference to an illustrative example, a computing device may be instructed to load and display a large image file via a graphics editing application executing on a computing device. If the computing device does not have sufficient device memory available for processing the request, the operating system can temporarily load one or more sections of the device memory and image file into a longer latency storage such as a hard drive or flash memory storage. Thereafter, the operating system can replace information stored in the device memory and the longer latency storage, often referred to as swapping. In many cases, swapping memory may be a slow and time consuming process. Continuing the illustrative example, the user may also request that the graphics editing application perform an image manipulation operation on the image file. Accordingly, the graphics editing application may cause the execution of a sub-process consisting of series of executable instructions corresponding to the image manipulation operation. If the image file is large, if the computing device has limited computational resources available, or if the transformation is computationally complex, the sub-process may take a substantial amount of time to complete, and may impact the execution of other processes, such as applications and operating system sub-processes, simultaneously executing on the device.

From the perspective of the user utilizing a client computing device, the user experience can be defined in terms of the performance and latencies associated with the execution of various software processes on a computing device. Latencies and performance limitations of any of the above processes may diminish the user experience. Additionally, latencies and inefficiencies may be especially apparent on computing devices with limited resources, such as processing power, memory or network connectivity, such as netbooks, tablets, smartphones, and the like.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a networked computing environment including a client computing device and a network computing provider;

FIG. 2 is a block diagram of the networked computing environment of FIG. 1 illustrating the instantiation of a new software process and a remote session between a client computing device and a network computing provider;

FIG. 3 is a block diagram of the networked computing environment of FIG. 1 illustrating the processing of application data between a network computing provider and a client computing device;

FIG. 4 is a block diagram of the networked computing environment of FIG. 1 illustrating the instantiation of a new remote session between a client computing device and a network computing provider;

FIG. 5 is a block diagram of the networked computing environment of FIG. 1 illustrating the determination of remote session configuration information and the instantiation of a new remote session at a network computing provider;

FIG. 6 is a flow diagram illustrative of a client new remote session routine implemented by a client computing device;

FIG. 7 is a flow diagram illustrative of a new remote session routine implemented by a network computing provider; and

FIG. 8 is a flow diagram illustrative of a remote session user interaction routine implemented by a client computing device.

### DETAILED DESCRIPTION

Generally described, the present disclosure is directed to the generation and management of a software process remote session between a client computing device and one or more remote network computing providers. Specifically, aspects of the disclosure will be described with regard to the processing of software processes to generate process data and processing results between client computing devices and the network computing providers in accordance with remote session configuration information. Although aspects of the embodiments described in the disclosure may describe, for the purpose of illustration, the management of one or more remote sessions corresponding to a software application, one skilled in the art will appreciate that the techniques disclosed herein may be applied to any number of software processes including, but not limited to, operating system processes and services. Further, although various aspects of the disclosure will be described with regard to illustrative examples and embodiments, one skilled in the art will appreciate that the disclosed embodiments and examples should not be construed as limiting.

With reference to a specific illustrative example, a user may request that a client computing device load a software process instance such as a software application process (henceforth referred to as an “application”). In one embodiment, subsequent to being loaded, the application may correspond to a number of computer-executable instructions designed to be executed at the client computing device. Illustratively, a set of the computer-executable instructions may be referred to as a “sub-process” and may be associated with the implementation of specific functionality or actions.

For the purpose of a specific example, assume a graphic editing application may load an image into memory for processing. A user may request that an image filter be applied to the image in memory. In accordance with this example, the image filter may correspond to a sub-process that manipulates the image data in memory in accordance with the configuration of the filter (e.g., adjusting color values or removing visual artifacts).

Subsequent to the receipt of the request, the client computing device obtains software process configuration information associated with the execution of the selected sub-processes. In one embodiment, the software process configuration information may include information identifying one or more sub-processes associated with the application as well as information specifying sub-process resource usage or processing requirements. The client computing device may further obtain various information relating to the device state, including, but not limited to, a current or future availability of device resources (e.g., processing power, memory, storage, network usage, etc.).

Using the software process configuration information as well as information associated with the device state or resource availability, the client computing device may identify one or more sub-processes of the application for remote execution in one or more remote sessions executing at a network computing provider, which can be embodied as remote session configuration information. The remote session configuration information may identify one or more communication protocols for the packaging and transfer of process data and processing results between the remote session at the network computing provider and the application instance at the client computing device.

Subsequent to a determination of remote session configuration information by the client computing device, the client computing device may cause the local instantiation of one or more components of the application. The client computing device may further provide the remote session configuration information to the network computing provider. Based on the remote session configuration information, the network computing provider may instantiate or cause to have instantiated one or more remote sessions, such as computing components associated with the network computing provider that will execute at least some portion of a sub-routine of the application. For example, the network computing provider may instantiate a computing component to host one or more software processes corresponding to sub-processes of the application being instantiated at the client computing device. In a further example, in one embodiment, the network computing provider can instantiate, or cause to have instantiated, an instance of a virtual machine that includes a parallel copy of the application instantiated at the client computing device.

The network computing provider may obtain initial process data from the client computing device for processing at the one or more remote sessions. The one or more remote sessions may process the initial process data, and may transmit processing results back to the client computing device. The information exchanged between the remote session on the instantiated network computing component and the application on the client computing device including, but not limited to, process data and processing results, can be generally referred to as “remote session information.” Upon receiving the processing results, the client computing device may provide the processing results to the application for further processing and/or presentation to the user. In one embodiment, the transmittal and processing of process data at the network computing provider may be transparent to the application executing at the client computing device. However, from the perspective of a user of the client the processing results may appear to have been generated by sub-processes executing locally at the client computing device.

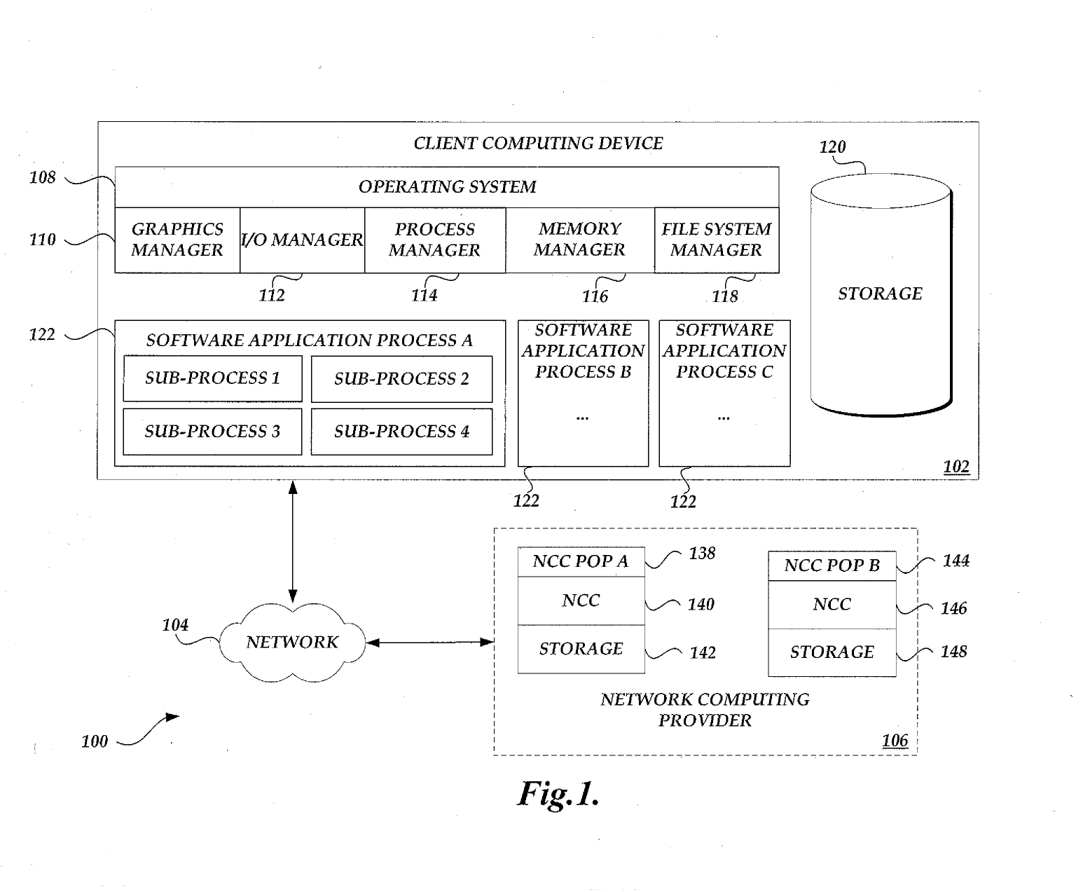

FIG. 1 is a block diagram illustrative of a networked computing environment 100 including a client computing device 102 and a network computing provider 106. As illustrated in FIG. 1, the networked computing environment 100 includes a client computing device 102 for running software processes such as software application processes 122 and operating system 108. In an illustrative embodiment, the client computing device 102 can correspond to a wide variety of computing devices including personal computing devices, laptop computing devices, hand-held computing devices, terminal computing devices, mobile devices (e.g., mobile phones, tablet computing devices, etc.), wireless devices, various electronic devices and appliances, and the like. In an illustrative embodiment, the client computing device 102 includes necessary hardware and software components for establishing communications over a communication network 104, such as a wide area network or local area network. For example, the client computing device 102 may be equipped with networking equipment and browser software applications that facilitate communications via the Internet or an intranet. The client computing device 102 may have varied local computing resources such as central processing units and architectures, memory, mass storage, graphics processing units, communication network availability, and bandwidth, etc.

In one embodiment, the client computing device 102 may run an operating system 108 consisting of one or more operating system processes such as a graphics manager 110, an input/output manager (“I/O manager”) 112, a process manager 114, a memory manager 116, and a file system manager. Illustratively, the graphics manager 110 may handle graphics processing and output of data and content for display on an output device. The I/O manager 112 may handle input and output functionality, as well as managing network protocols and network usage and access between the client computing device 102 and other networked devices across the communications network 104. The memory manager 116 may manage allocation of memory between software processes, and may handle virtual memory and memory caching on the client computing device. The file system manager 118 may manage the storage and retrieval of files and data on a storage component 120, including but not limited to a hard drive, flash memory, network drive, or other local or remote storage component. In various other embodiments, an operating system 108 may include fewer, more, or any combination of operating system processes as depicted here for the purpose of illustration.

The process manager 114 may manage the execution, loading, and scheduling of one or more software application processes 122 executable on the client computing device 102. Illustratively, each software application process 122 may include any number of sub-processes consisting of a plurality of logically associated device executable instructions.

With further continued reference to FIG. 1, the networked computing environment 100 can also include a network computing provider 106 in communication with the client computing device 102 via the communication network 104. The network computing provider 106 illustrated in FIG. 1 also corresponds to a logical association of one or more computing devices associated with a network computing provider. Specifically, the network computing provider 106 can include a number of Point of Presence (“POP”) locations 138, 144 that correspond to nodes on the communication network 104. Each POP 138, 144 includes a network computing component (NCC) 140, 146 for hosting applications such as software application processes 122 or sub-processes thereof via a number of instances of a virtual machine, generally referred to as an instance of an NCC. One skilled in the relevant art will appreciate that NCC 140, 146 would include physical computing device resources and software to provide the multiple instances of a virtual machine or to dynamically cause the creation of instances of a virtual machine. Such creation can be based on a specific request, such as from a client computing device, or the NCC can initiate dynamic creation of an instance of a virtual machine on its own. Each NCC POP 138, 144 also includes a storage component 142, 148 made up of a number of storage devices for storing any type of data used in the delivery and processing of network or computing resources, including, but not limited to, user data, state information, processing requirements, historical usage data, and resources from content providers that will be processed by an instance of an NCC 140, 146 and transmitted to various client computers, etc. In some embodiments, the network computing provider 107 may be considered as a network computing and storage provider. The NCCs 140, 146 and the storage components 142, 148 may further include additional software and/or hardware components that facilitate communications including, but not limited to, load balancing or load sharing software/hardware components for selecting instances of a virtual machine supporting a requested application and/or providing information to a DNS nameserver to facilitate request routing.

In an illustrative embodiment, NCCs 138, 146 and the storage components 142, 148 are considered to be logically grouped, regardless of whether the components, or portions of the components, are physically separate. For example, a network computing provider 106 may maintain separate POPs for providing the NCC and the storage components. Additionally, although the NCC POPs 136, 144 are illustrated in FIG. 1 as logically associated with a network computing provider 106, the NCC POPs will be geographically distributed throughout the communication network 104 in a manner to best serve various demographics of client computing devices 102. Additionally, one skilled in the relevant art will appreciate that the network computing provider 106 can be associated with various additional computing resources, such additional computing devices for administration of content and resources, and the like.

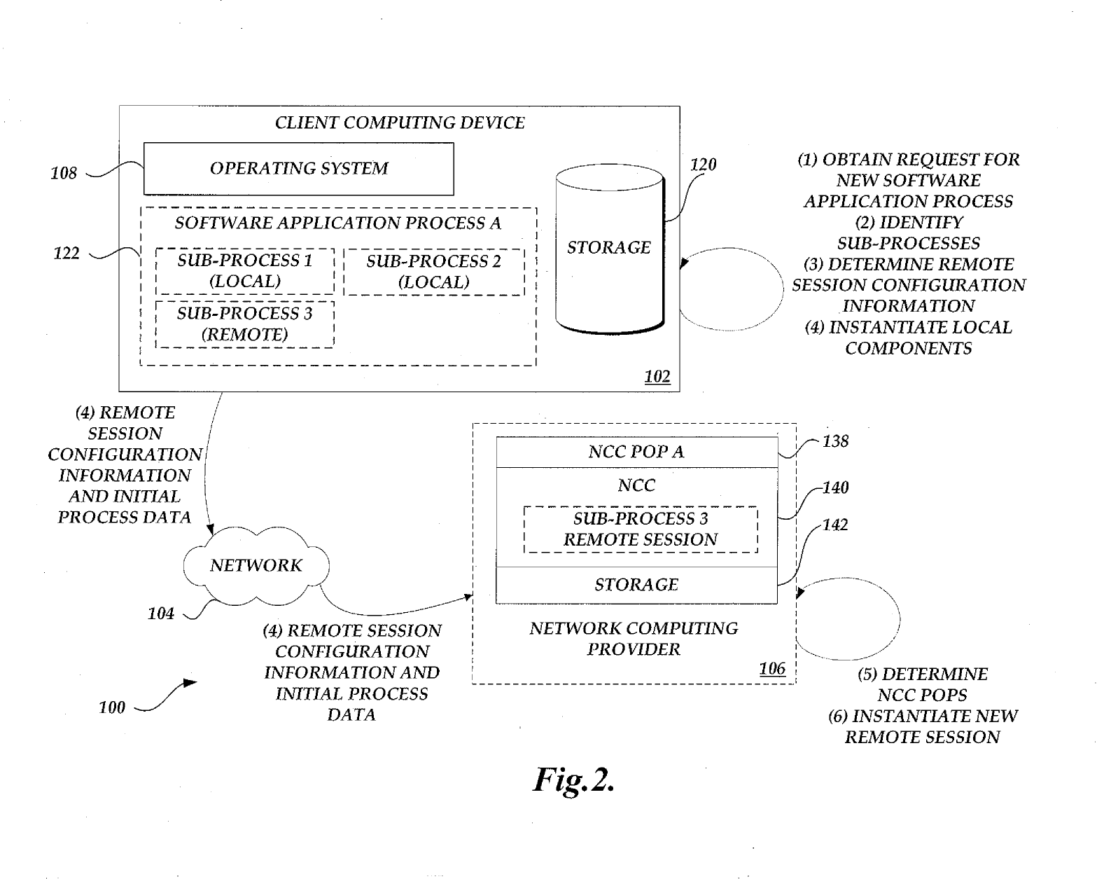

With reference now to FIGS. 2-5, the interaction between various components of the networked computing environment 100 of FIG. 1 will be illustrated. Specifically, FIGS. 2-5 illustrate the interaction between various components of the networked computing environment 100 for the remote processing of process data between the client computing device 102 and the network computing provider 106. For purposes of the example, however, the illustration has been simplified such that many of the components utilized to facilitate communications are not shown. One skilled in the relevant art will appreciate that such components can be utilized and that additional interactions would accordingly occur without departing from the spirit and scope of the present disclosure.

With reference to FIG. 2, the process can begin with the instantiation of a new software process and a remote session between a client computing device 102 and a network computing provider 106. Illustratively, the client computing device 102 may begin loading a software application process 122 in response to an event or user request. In one embodiment, loading a software application 122 may include copying executable code from a storage component 120 into device memory. As the software application process 122 is loaded, the client computing device 102 may identify one or more sub-processes of the application 122. Illustratively, each sub-process may consist of a number of logically associated executable instructions performing an aspect of the application's 122 functionality. In various embodiments, the client computing device may identify one or more sub-processes based on stored software process configuration information associated with the application 122, previous or current monitoring of the application's 122 execution, monitoring of execution of one or more related applications (e.g., different, but similar versions of the application 122), or based on any other factor or piece of information. Subsequent to the identification of sub-processes of the application 122, the client computing device 102 may determine remote session configuration information defining a set of sub-processes to execute remotely, and a communications protocol for data transport between the client computing device 102 and the network computing provider. The client computing device may then instantiate any local components of the application 122 at the client computing device. In one embodiment, the client computing device 102 may block the execution or loading of one or more aspects of one or more sub-processes identified as candidates for remote analogues within the local application 122, as the functions of these sub-process are being or are to be performed by a remote session at the network computing provider 106.

Subsequent to determining remote session configuration information, the client computing device 102 may transmit the remote session configuration information and/or initial process data to be processed to the network computing provider 106. In one embodiment, from the perspective of the application 122 being loaded on the client computing device, instantiating a remote session to handle execution of a sub-process may appear just as though the sub-process was being instantiated and executed on the local device.

Subsequent to the receipt of the remote session configuration information, the network computing provider 106 may select one or more associated network computing component (hereinafter “NCC”) point of presences (hereinafter “POP”) such as NCC POP 138 to service any requested new remote sessions. The selection of the NCC POP may determine the processing and network resources available to the instantiated virtual machine. The selection of processing and network resources and the provisioning of software at the NCC POP instance may be done, at least in part, in order to optimize processing resources and communication with the client computing device 102. The selected NCC POP 138 may generate a remote session corresponding to one or more sub-processes of the application 122 as identified in the remote session configuration information. Illustratively, instantiating a new remote session may include loading a new virtual machine instance, set of executable instructions, and/or application instance at the NCC POP 138, reserving or allocating device memory, storage or cache space, processor time, network bandwidth, or other computational or network resources for the new remote session.

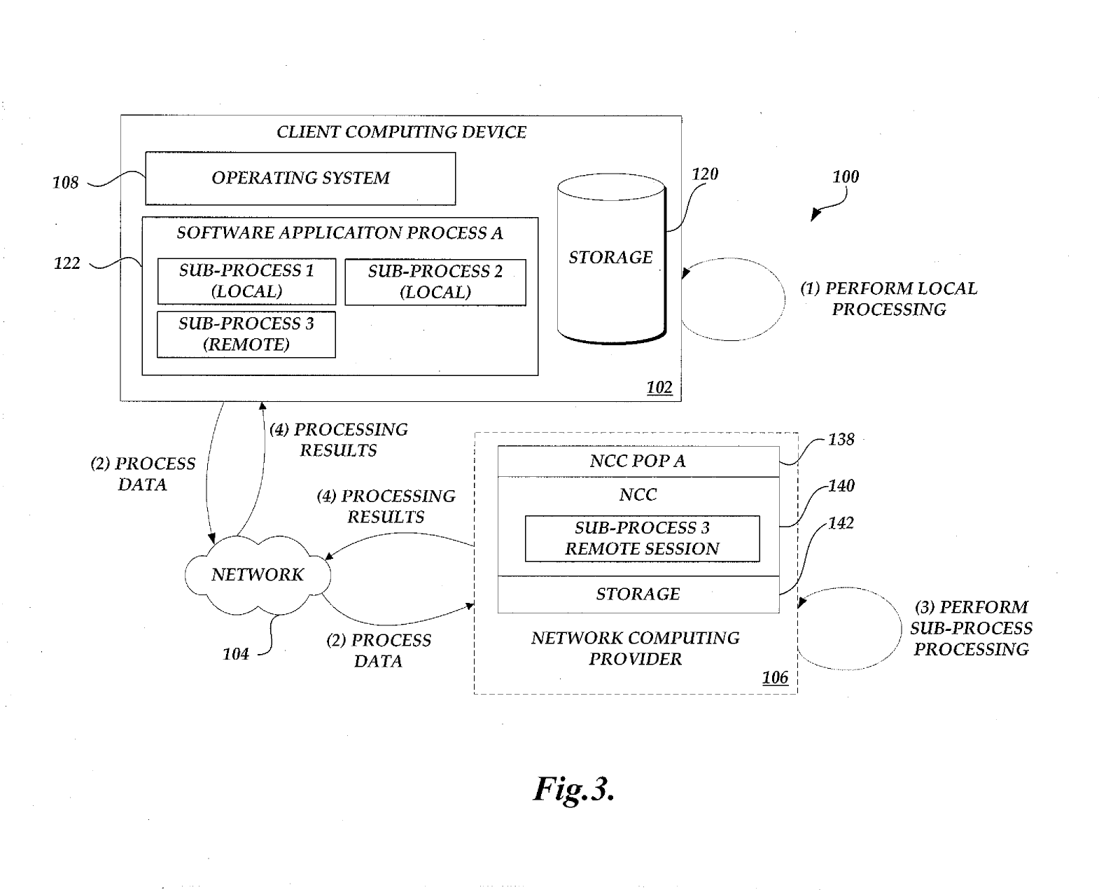

With reference to FIG. 3, an illustrative interaction for processing of application data between a network computing provider 106 and a client computing device 102 will be described. As illustrated in FIG. 3, the selected NCC POP 138 may have instantiated one or more remote session corresponding to an application 122 based on remote session configuration information, such as the remote session configuration information depicted in FIG. 2 above.

Subsequent to initializing the new remote session instance, NCC POP 138 may process any initial process data provided with the remote session configuration information to the network computing provider 106 by the client computing device 102, such as the initial process data depicted in FIG. 2 above. Simultaneously, prior, or subsequently to the processing of the initial process data at the NCC POP 138, the client computing device 102 may perform local processing corresponding to any sub-processes of the application 122 executing locally at the client computing device 122. As the NCC POP 138 completes its processing of the initial process data, it may transmit processing results back to the application 122 running on the client computing device 102 through the network 104. In one embodiment, these processing results may be transmitted according to a communications protocol identified in the remote session configuration information. From the perspective of the application 122, the processing results provided by the NCC POP 138 may appear to have been generated by a thread or other sub-process executing locally at the client computing device.

As the application 122 processes data locally and receives interactions from the user at client device 102, the application 122 may transmit additional process data associated with one or more sub-process corresponding to a remote session to the network computing provider 106. In one embodiment, the network computing provider 106 may process this process data as described above and transmit additional processing results back to the application 122 at the client computing device 102. Any sub-processes of the application 122 executing at the client computing device 102 may execute normally.

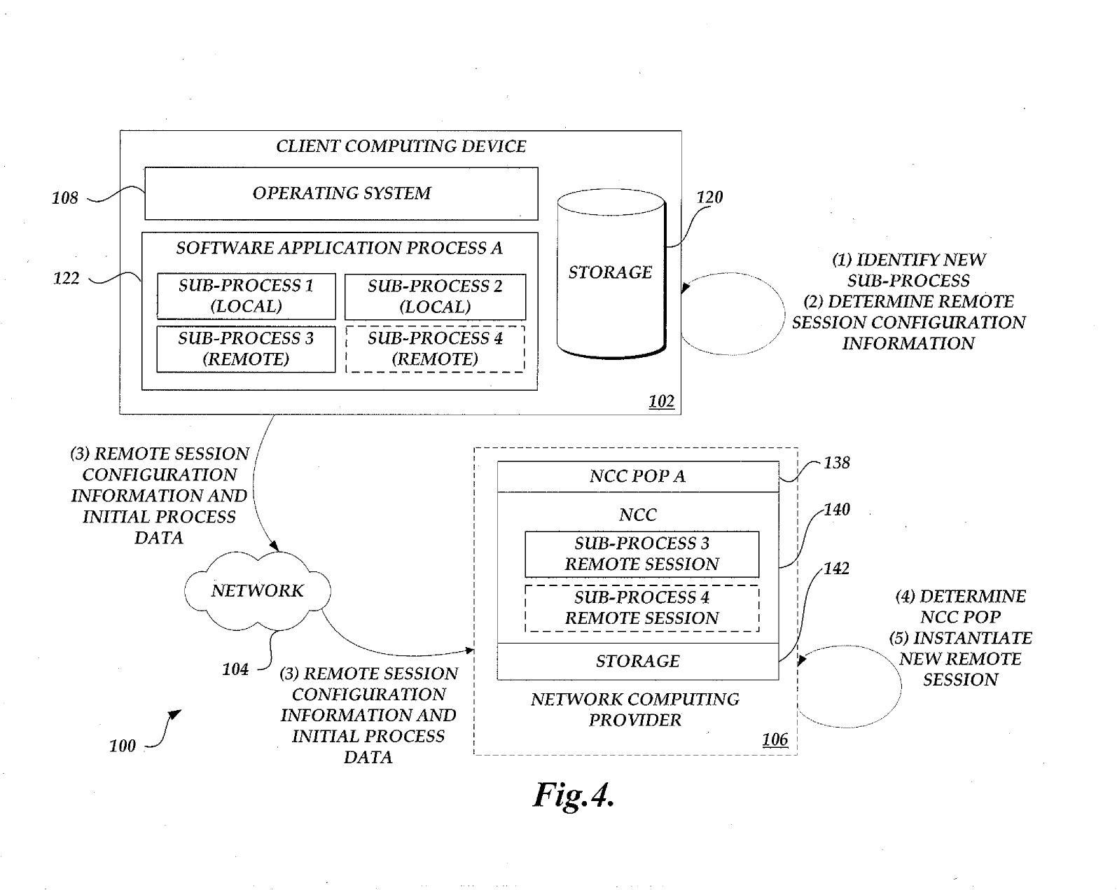

With reference to FIG. 4, a block diagram of the networked computing environment of FIG. 1 illustrating the instantiation of a new remote session between a client computing device 102 and a network computing provider 106 is disclosed. As illustrated in FIGS. 2 and 3, a first remote session may be instantiated at network computing provider 106 corresponding to an application 122 executing on client computing device 102.

The instantiation of a new remote session may begin with the application 122 beginning to load or execute a new sub-process at the client computing device 102. Illustratively, the loading or execution of a new sub-process may occur as a result of the application 122 beginning a new processing operation on application content. For example, a graphic editing application may begin executing a new sub-process consisting of an image manipulation operation on a large image file. In another embodiment, the loading or execution of a new sub-process may correspond to a request to load a new piece of application content. For example, a new video editing application sub-process may correspond to the loading of a new video clip for editing. Illustratively, the loading or executing of a new sub-process may occur in response to a user interaction or request, a system or application event, or any other triggering event or cause.

Subsequent to the client computing device 102 identifying a new sub-process, the client computing device 102 may determine remote session configuration information for the new sub-process, as discussed above with reference to FIG. 2. As discussed above, the remote session configuration information may specify remote session execution for the identified sub-process and/or a communications protocol for exchange of data between the remote session and the application 122 executing at the client computing device 102. The client computing device 102 may transmit remote session configuration information and/or initial process data for processing to the network computing provider 106. As discussed above with reference to FIG. 2, the network computing provider 106 may determine an NCC POP 138 to handle the new remote session request, and may cause the instantiation of the new remote session corresponding to the new sub-process at the NCC POP 138.

As discussed above with reference to FIG. 2, a network computing provider 106 may select an NCC POP to instantiate a new remote session based on any number of factors, including, but not limited to, available NCC POP resources (e.g., available memory, processor load, network load, etc), a financial cost of hosting the remote session at the NCC POP, the NCC POP location respective to a client computing device 102, a content provider, CDN, or NCC POP cache status (e.g., whether a requested resource is already stored in an NCC POP cache), etc. Illustratively, although the network computing provider 106 is depicted here for purposes of illustration as selecting NCC POP 138, the network computing provider 106 may select any extant NCC POP to instantiate the new remote session. For example, a single client computing device 102 may simultaneously or sequentially provide remote session configuration information to the network computing provider 106 corresponding to three different requests for remote sessions. The network computing provider 106 may select different NCC POPs to instantiate each remote session, the same NCC POP for all three remote sessions, or any combination thereof. As discussed above, the decision whether to select a different NCC POP than was utilized for a previous or simultaneous remote session may be made on the basis of available system resources, randomly, or according to any other factor as discussed above and with regards to FIG. 2. In one embodiment, the client computing device 102 may block the execution or loading of one or more aspects of the new sub-process within the local application 122, as the functions of the sub-process are being or are to be performed by the new remote session at NCC POP 138.

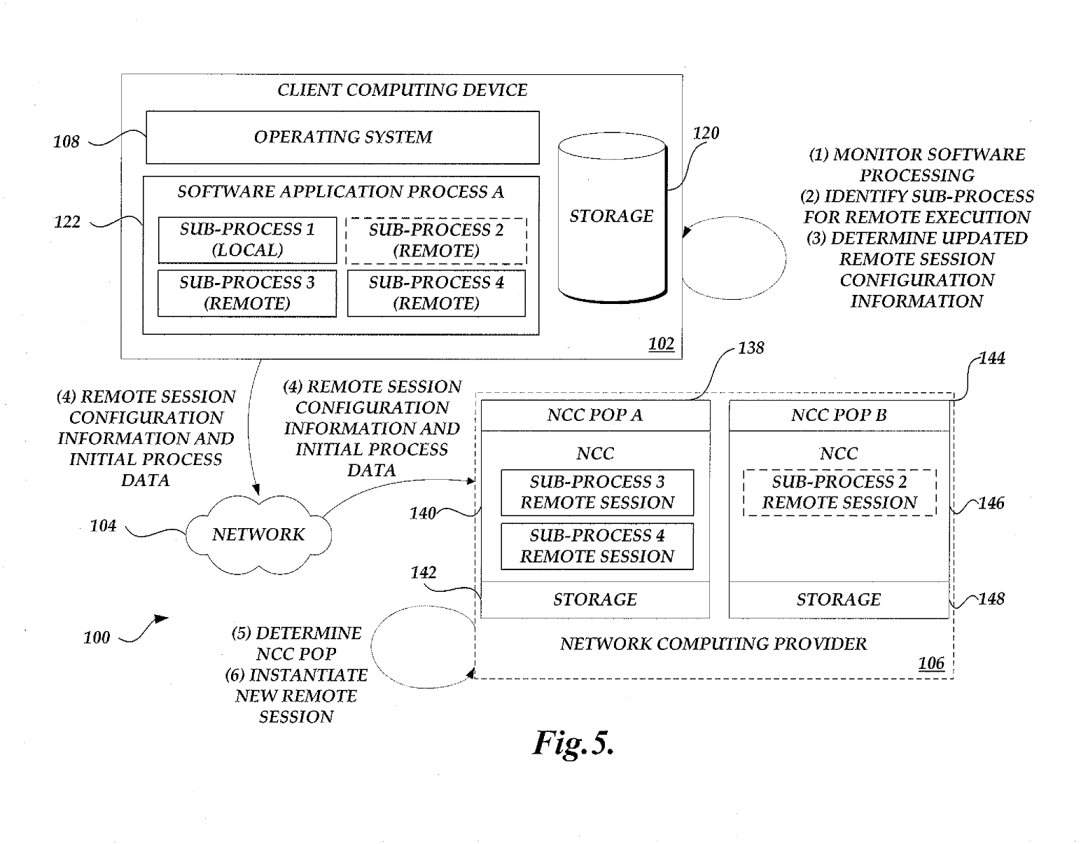

With reference to FIG. 5, a block diagram of the networked computing environment of FIG. 1 illustrating the determination of remote session configuration information and the instantiation of a new remote session at a network computing provider 106 is disclosed. As illustrated in FIGS. 2-4, one or more remote sessions may be instantiated at network computing provider 106 corresponding to an application 122 executing on client computing device 102.

In one embodiment, the client computing device 102 may monitor the operation of one or more applications 122 or other processes executing at the client computing device 102. For example, the client computing device may monitor memory usage, network usage, processor usage, etc. The client computing device 102 may additionally monitor aggregate performance and computing requirements for any number of processes in order to determine overall resource availability, prioritize executing processes, maintain responsiveness of operating system 108, and the like. Based on the monitoring, the client computing device 102 may identify a sub-process of the application 122 for remote execution. As a specific example, the client computing device 102 may identify a local sub-process such as SUB-PROCESS 2 that is consuming a large amount of system resources and may easily be moved to a remote session.

Subsequent to identifying a sub-process that may be moved to a remote session, the client computing device 102 may update remote session configuration information for the application. As described with reference to FIGS. 2-4, the remote session configuration information may include information about the identified sub-process and the request for a new remote session corresponding to the identified sub-process, as well as a communications protocol for packaging and transmission of information between the client computing device 102 and the network computing provider 106. The client computing device 102 may transmit the updated remote session configuration information and/or any initial process data for processing by the new remote session to the network computing provider 106.

The network computing provider may select an NCC POP 144 and cause instantiation of a new remote session at the NCC POP 144 corresponding to the sub-process of the application 122. As discussed above with reference to FIG. 3, the network computing provider may select any of the same or different NCC POP 144 as is hosting any other remote sessions associated with the client computing device 102 or application 122. In one embodiment, the client computing device 102 may pause execution or un-load one or more aspects of the previously-local sub-process from memory as the functions of the sub-process are performed by the remote session at NCC POP 144.

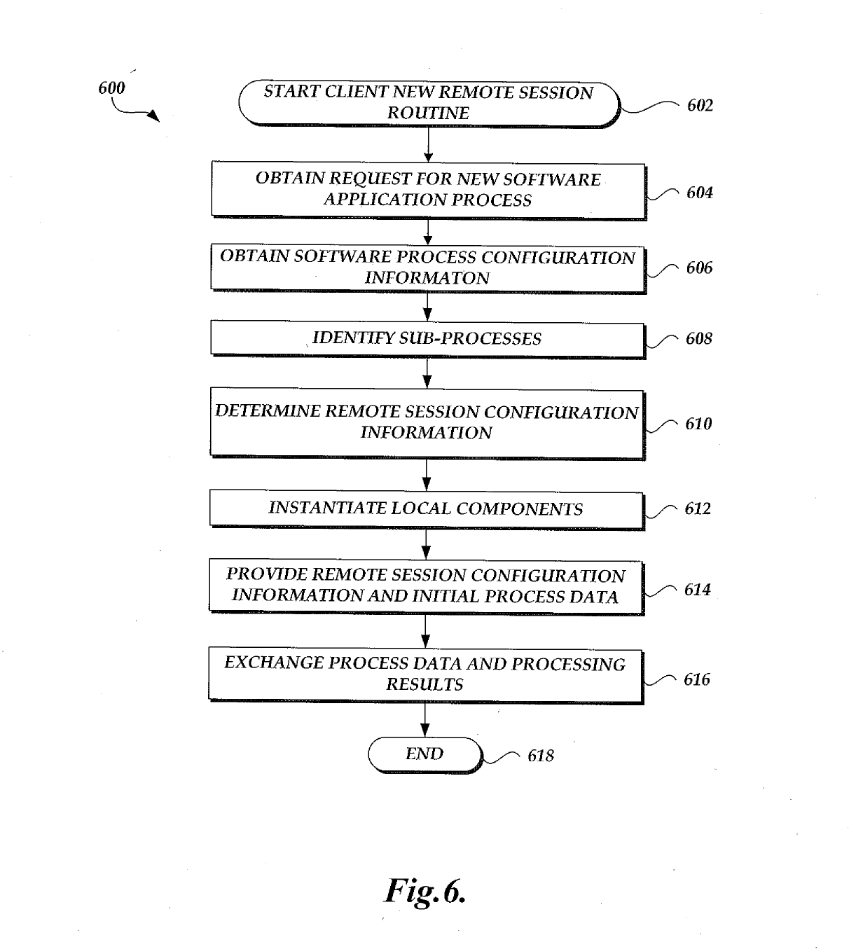

FIG. 6 is a flow diagram illustrative of a client new remote process routine implemented by the client computing device 102 of FIG. 1. Client new remote session routine 600 begins at block 602. At block 604, the client computing device 102 obtains a request to instantiate a new software application process 122 or other software process. In one embodiment, obtaining a request to instantiate a new software application process 122 may be the result of a request or interaction by a user at the client computing device 102. For example, a user may open an application 122 on the client computing device 102. In another embodiment, obtaining a request to instantiate a new software process may be the result of an automatic process or event executing at the client computing device 102. Although the new software process is referred to herein for purposes of illustration as an application 122, one of skill in the relevant art will appreciate that any software process including, but not limited to a operating system process, a service, a daemon, or any other type of software process executable on the client computing device 102. Although the client computing device 102 is described here for purposes of illustration as determining software process configuration information, remote session configuration information, and other aspects of information relating to a remote process, it should be understood that one or more of these determinations may be performed by the network computing provider 106 and/or any other third-party service, device, or entity.

Subsequent to obtaining a request to instantiate a new software process, the client computing device 102 may obtain software process configuration information associated with the application 122 or other software process at block 606. Illustratively, software process configuration information may include any kind of information about the application 122 including, but not limited to, information on processing, memory or bandwidth requirements, information on threads and execution scheduling, information on data, application, or sub-process security, information on application execution history and/or user interaction history or behavior, or any other information about the application. In one embodiment, one or more aspects of software process configuration information may have been predefined by an application developer and included in data associated with the application 122 at the application's storage location, obtainable from a network storage location associated with the application, predefined by a user, operating system, or other third party entity, or obtained from any other source. In a further embodiment, one or more aspects of software process configuration information may be determined based on process execution data associated with a resource footprint, execution behavior, or any other execution characteristic of a process and/or one or more sub-processes. Illustratively, the process execution data may be generated based on monitoring and/or current or past observations of an application's execution or on a user's interaction with the application 122. In one embodiment, data from any number of devices running an application 122 may be aggregated at a network component in order to obtain or determine process execution data. Illustratively, combining data from multiple instances of an application may help provide a well-defined or aggregate characterization of the application 122. Process execution data may be based on the monitoring of one or more instances of the application 122, and/or may be based on the monitoring of one or more instances of related applications (e.g., same, different, or similar versions of the application 122). In a further embodiment, process execution data may be provided by an application developer or third-party application data provider based on observed or expected resource footprints, execution behavior, or other characteristic.

At block 608, the client computing device 102 identifies one or more sub-processes associated with the application 122. In one embodiment, the client computing device 102 may identify sub-processes based on information included in the software process configuration information. Illustratively, a sub-process may consist of a number of logically associated executable instructions. For example, the application 122 may include any number of device instructions executing at the client computing device 102. A sub-process may consist of a logically associated group of these device instructions that together perform an aspect of the application's functionality. In one embodiment, one or more sub-processes may form discrete functions for processing data, and may accordingly be separable from the software application process 122 to a greater or lesser degree. For the purpose of a specific example, a graphic editing application may load an image into memory for processing. A user may request that an image filter be applied to the image in memory. In one embodiment, the image filter may consist of a sub-process such as a series of executable instructions that manipulate the image data in memory. In one embodiment, the image filter sub-process may be logically separable from one or more other sub-processes (e.g., interface component management, file management, other image or data processing processes, etc.) together making up the graphic editing application.

Subsequent to identifying one or more sub-processes at block 608, the client computing device may determine remote session configuration information at block 610. Illustratively, the remote session configuration information may correspond to a remote session configuration, illustratively including information identifying one or more of the sub-processes identified at block 608 to execute in a remote session at a network computing provider 106. In one embodiment, the remote session configuration information may define aspects of one or more sub-processes to be performed in a remote session, as well as any data translation interfaces required at the client computing device 102 or network computing provider 106. For example, a processing result received by the client computing device 102 corresponding to data processed by a remote session may have to be further processed, translated, and/or placed into appropriate places in memory, processor registers, caches, or data storage locations in order to be available to the application 122. As discussed below, the split of processing actions may be associated with, or linked to the communication protocol used for exchanging process data and processing results between the network computing provider 106 and client computing device 102. The remote session configuration information may further include information regarding the expected computational requirements of each anticipated remote session, such as processing requirements, memory requirements, network requirements, etc. Illustratively, this information may allow the network computing provider 106 to select an appropriate NCC POP to host each remote session.

The remote session configuration information may still further include information regarding a communications protocol defining the packaging and transmission of data between the client computing device 102 and the network computing provider 106, including, but not limited to, a network protocol, signaling model, transport mechanism, or encapsulation format for the exchange of state data, user interactions, and other data and content between the network computing provider 106 and the client computing device 102. A communications protocol for the exchange of data may include any communications protocol known in the art, including, but not limited to, HTTP, FTP, Remote Desktop Protocol (RDP), X-Windows protocol, Virtual Network Computing (VNC) protocol, X-Windows protocol, Remote Frame Buffer protocol, or any other proprietary or public communications protocol. For example, RDP illustratively specifies a number of processing mechanisms for encoding client input (e.g., mouse movement, keyboard input, etc.) into protocol data units for provision to a remote computing device, and corresponding mechanisms for sending bitmap updates and low level interface information back to the client device. As another example, the HTML protocol illustratively provides a mechanism for providing files defining interface information and containing resources references from a server to a client, and a corresponding mechanism for a client computing device to provide requests for additional files and resources to the server.

Illustratively, the remote session configuration information may additionally specify one or more encodings or data formats for process data, processing results, and other information transferred between the client computing device 102 and the network computing provider 106 or other device. In various embodiment, data may be transferred in any number of formats, including, but not limited to, one or more encoding or compression format, a text format, a code format, a markup format (e.g., Extensible Markup Language, Hypertext Markup Language, etc.), a data interchange format (e.g., Extensible Markup Language, JavaScript Object Notation, Data Interchange Format) an executable binary format, an image format (e.g., jpeg, gif, tiff, bitmap, etc.), a video format (e.g., mpeg, avi, mov, etc), an audio format (e.g., aiff, mp3, etc.), or any other binary, document, or other data format known in the art. For example, in one embodiment, the remote session configuration information may specify that software code stored in a text format be provided as process data to the network computing provider 106, and that the network computing provider 106 transfer processing results including an executable binary corresponding to the compiled software code back to the client computing device 102.

As discussed above, the remote session configuration information may specify a remote configuration for one or more of the sub-processes identified in block 608 above. Illustratively, the remote session configuration information may specify that a sub-process is performed locally, performed entirely remotely, or performed in some combination of local and remote processing (e.g., the majority of processing occurs at the network computing provider 106, but the client computing device 102 executes local translations components to translate and display received processing results). In one embodiment, the determination of a remote configuration for one or more sub-processes of the application 122 may be performed at the client computing device 102 by the application itself, by an operating system process or service, or by any other process executing at the client computing device. In other embodiments, the network computing provider 106 may perform or assist in the performance of the determination. As described herein for the purposes of illustration, the client computing device will be discussed as performing the determination of remote configurations for identified sub-processes of the application; however this may vary according to alternate embodiments.

The client computing device 102 may base its determination of a remote configuration for one or more of the sub-processes identified in block 608 on any number of factors, including, but not limited to, one or more characteristics of application data, a computational profile of the sub-process (e.g., memory usage, processor usage, storage usage, network usage), one or more characteristics or configurations of the client computing device 102, current resource usage at the client computing device, characteristics, resource usage, or configurations of the network computing provider 106 or NCC POP 138, one or more characteristics of the network or network connection, a configuration or preferences associated with a user, predefined configurations or preferences, etc. Characteristics of application data may include, but are not limited to, a data format, a content type, a size, processing requirements, resource latency requirements, a number or type of interactive elements, a security risk, an associated user preference, a storage location or remote storage network address, an associated network domain, an associated content provider, etc. Characteristics of a client computing device 102, network computing provider 106, NCC POP 138, and other associated services or devices may include, but are not limited to, a processing power, memory, storage, network connectivity (e.g., available bandwidth, latency, or consistency), a physical or logical location, predicted stability or risk of failure, a software or hardware profile, current, past, or predicted future available resources (e.g., available memory or processing, or the number of concurrently open software applications), etc. Characteristics of an application 122 may include, but are not limited to, predefined remote configurations (e.g., remote configurations defined by an application developer, user, operating system, remote service, etc.), an interactivity of the application, a past, current, or predicted resource usage of the application 122, a size and/or complexity of the application 122, licensing or copyright issues regarding the distribution of code associated with the application 122, etc.

The client computing device 102 may further consider perceived security threats or risks associated with a piece of content or domain, preferences of a client computing device 102 or network computing provider 106, computing costs (e.g., a financial cost of processing or bandwidth, resource usage, etc.), predetermined preferences or selection information, any additional processing overhead required by a particular remote session, a cache status (e.g., whether a particular resource is cached at a NCC POP 138, at the client computing device 102, or at other network storage components associated with the network computing provider 106), a predicted delay or time required to retrieve application code or process data, a preferred network computing provider or agreements with a network computing provider for a particular remote session or level of service, whether a remote session associated with an application, user, client computing device, or network computing provider is currently active, or any other factor.

In some embodiments, a client computing device 102 may base a determination of a remote session for a particular sub-process on past behavior or practice. For example, a client computing device 102 that has determined a remote configuration for a particular sub-process in the past may automatically select the same remote configuration when the application is loaded by the same (or potentially a different) user. As another example, a user that has a history of utilizing an application in a manner that requires extensive processing may cause the determination of remote process configuration information that specifies performing a majority of sub-processes in remote sessions. In other embodiments, the client computing device 102 may base a determination of remote process configuration information on predictions of future behavior. For example, the client computing device 102 may base its determination of remote process configuration information on an analysis of past determinations made for a particular application. Sub-processes in the application that have historically required large amounts of computational resources may be performed partially or entirely in remote sessions at the network computing provider 106. Illustratively, past historical analysis and future predictions may be considered as one or more of a number of factors on which to base the remote process configuration information, or may be definitive in the decision making process. Illustratively, as described with reference to FIG. 5 above, the client computing device may monitor application processing and use of resources as the application runs, and may at any point re-determine updated remote process configuration information. Illustratively, this updated remote process configuration information may move sub-processes or aspects of sub-processes from local execution to a remote session, from a remote session to local execution, or any combination thereof.

In other embodiments, a piece of application content, an application, or information associated with an application may specify or otherwise request the remote processing of particular sub-processes or the use of particular remote process configuration information in a resource tag, metadata, or other form. The client computing device 102 may treat the request as definitive, or may consider the request as one of multiple factors to be considered in the decision making process.

Illustratively, the client computing device 102 may base a determination of remote session configuration information on any factor or combination of factors. For example, the client computing device 102 may determine remote session configuration information based on a single factor, or may assign weights to one or more factors in making a determination. In some embodiments, the determination process of the client computing device 102 may change based on one or more factors described above. For example, a client computing device 102 communicating with a network computing provider 106 over a network with a surplus of unused bandwidth may give a low weight to factors such as the network requirements of a remote session, and may give a higher weight to factors such as the latency of user interactions with the application. In another embodiment, a client computing device 102 communicating with a network computing provider 106 over a limited bandwidth network or intermittent network connectivity may give a higher weight to factors dealing with the efficiency of communicating with the remote session over a network. Illustratively, any one or more aspects or parts of remote session configuration information may be determined by the client computing device 102, network computing provider 106, alternate computing device, and/or any other device, component, or entity. The determination of remote session configuration information may be based in whole or in part on data received, obtained, or collected from any combination of client computing device 102, network computing provider 106, alternate computing device, and/or any other device, component, or entity.

At block 612, the client computing device 102 may instantiate any components identified as local components or sub-processes by the remote session configuration information. The client computing device 102 may further instantiate any local components, such as data translation or display interfaces, required for the processing, translation, and/or display of processing results returned by remote sessions. As a specific example, the remote session configuration may have identified an application's user interface and related processing as a local sub-process, and may have identified the display and processing of an image in a content pane of the application to be a remote sub-process. In accordance with this example, the client computing device 102 may load interface component objects and related code associated with the application into memory at the client computing device. To continue this example, the client computing device 102 may further load data translation interfaces or components linked to the loaded local objects and code. The data translation interfaces or components may handle the processing and display of processing results received from the network computing provider 106 such as RDP display data corresponding to a representation of the image.

At block 614, the client computing device 102 may provide the remote session configuration information to a network computing provider 106. The client computing device 102 may also provide initial process data to the network computing provider 106. In an illustrative embodiment, the network computing provider 106 utilizes a registration API to receive remote session configuration information from the client computing device 102.

As discussed above with reference to blocks 610 and 612, the remote session configuration information may identify one or more application sub-processes to process as remote sessions. In one embodiment, the remote session configuration information may include executable code corresponding to one or more aspects of the identified sub-processes for execution at the network computing provider 106. In another embodiment, the remote session configuration information may include one or more references to executable code associated with the identified sub-processes for execution as a remote process. For example, a network computing provider 106 may have a copy of the application being run at the client computing device 102 in a local or networked storage component. In this example, the remote session configuration information may provide a reference or identification of the sub-process (e.g., the sets of instructions and/or objects) within the application that are associated with the remote session. In another embodiment, the remote session configuration information may include actual copies of executable code, objects, and/or data corresponding to the sub-process for use in instantiating the remote session at the network computing provider 106.

In one specific embodiment, the network computing provider 106 may cause the instantiation at an NCC POP 138 of a full instance of the application. For example, the network computing provider 106 may instantiate an application to run in parallel with the application executing at the client computing device 102. In another embodiment, the network computing provider 106 may instantiate and execute one or more remote sessions, each corresponding to a sub-process of the application executing at the client computing device.

The remote session configuration information provided to the network computing provider 106 may be accompanied or followed by initial process data for processing at the one or more remote sessions instantiated at the network computing provider 106. Illustratively, the initial process data may include a set of data, one or more references to data, or any combination thereof. For example, an application at the client computing device 102 may be loaded in response to a request by a user to edit a particular image. For the purpose of a specific example, we will assume that the remote session configuration information associated with the application specifies an image manipulation sub-process of the application to execute in a remote session at the network computing provider 106. Illustratively, the remote session may require a copy of the particular image on which to operate. In one embodiment, if the image is stored locally at the client computing device 102, the client computing device 102 may transmit a set of data comprising a copy of the image as initial process data to the client computing and storage provider. Illustratively, in various embodiments the client computing device may transmit the image in accordance with an API at the network computing provider 106, or according to one or more communication protocols as specified in the remote session configuration information.

To continue the specific example above, in another embodiment we can assume that the image is stored at a remote storage location, for example at a storage component associated with or accessible to the network computing provider 106, the client computing device 102 may provide the network computing provider 106 with initial process data including a network address and/or other information allowing the network computing provider 106 to obtain and/or load the image. In one embodiment, the image may be both stored locally at the client computing device 102, and cached or mirrored at one or more network storage components. Illustratively, with regards to this embodiment, the client computing device 102 could send a reference to the image stored in the cache and/or a checksum or hash to determine whether the cached image was the latest or correct copy. Illustratively, if the cached image was not the latest version of the image, the network computing provider 106 could request the new image from the client computing device 102 rather than obtaining an outdated image from the cache.

In various embodiments, the determination whether to provide a reference to data or actual data from the client computing device 102 to the network computing provider 106 may be made by the client computing device 102, the network computing provider 106, or any other device or component. Illustratively, the determination whether to provide a reference to data or actual data may be based on a number of factors, alone or in combination. Such factors, include, but are not limited to, connectivity or one or more characteristics of connectivity between a device and a data store or network component storing the data, characteristics of the data, characteristics of a connection between the computing device 102, the network computing provider 106, or other device, resource utilization at the computing device 102, the network computing provider 106, or other device, and the like. For example, assume a client computing device 102 only has intermittent communication network connectivity. The network computing device 106 may wish to receive a copy of the actual data when connectivity is available or in anticipation of a loss in connectivity. The data may be stored at any shared or local store, network component, or other data store associated with the network computing provider 106, client computing device 102, or any other device, entity, or component.

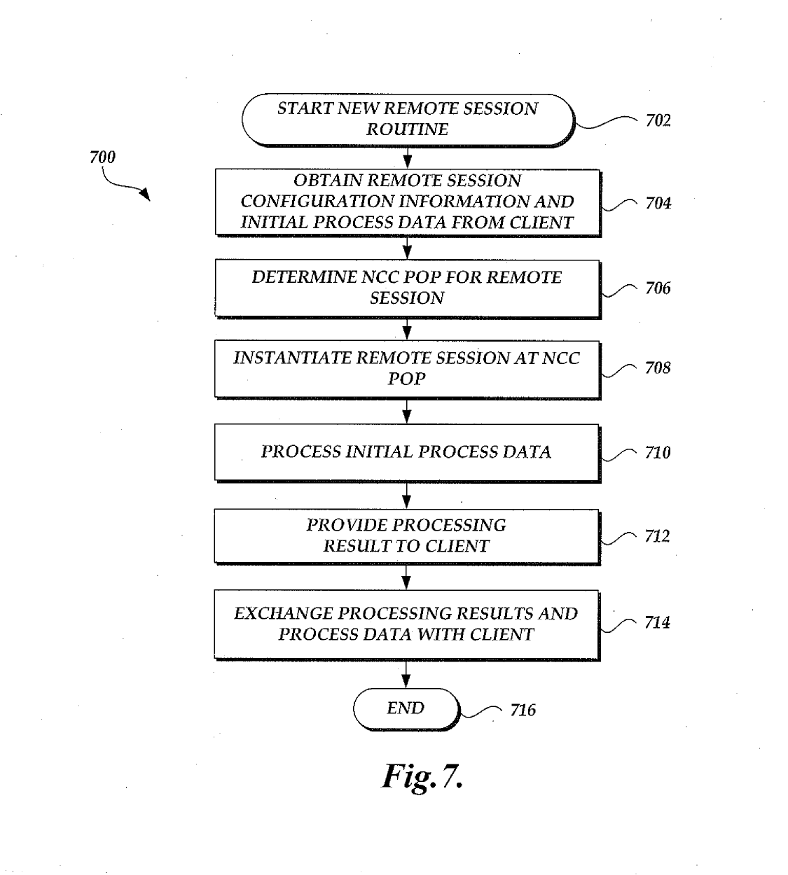

Subsequent to providing remote session configuration information and initial process data, the network computing provider 106 may instantiate one or more remote sessions corresponding to sub-processes of the application. An illustrative server side new remote session routine is discussed with greater detail below with reference to FIG. 7.

At block 616, the client computing device 102 may exchange process data and processing results with the remote session at the network computing provider 106. Illustratively, the network computing provider 106 may provide processing results to the client computing device 102 corresponding to the results of process data having been processed by a remote session. Illustratively, the processing results may be provided to the client computing device 102 in any form or format known in the art. In one embodiment, the form of a processing result may be determined by a communications protocol determined for the remote session in the remote session configuration information.

For example, remote session configuration information associated with a graphics processing application may specify that a remote session corresponding to a sub-process handling the processing of a set of data comprising a large image for display utilizes an RDP protocol for the transfer of processing results to the client computing device 102. Illustratively, the processing results may only correspond to a section or resolution of the image to be displayed at the client computing device, and so may be transferred more quickly than if the entire image file was required. In another embodiment, remote session configuration information associated with a database viewer application may specify that a remote session corresponding to a sub-process handling the execution of a search returning a large number of database tables may specify a transfer of processing results consisting of a compressed comma-separated value (CSV) format over an FTP protocol. As described above, the processing results may only correspond to a section of the set of data to be displayed at the client computing device, and so may only include a small sub-section of all results returned. Illustratively, a request by a user at the client computing device 102 to scroll down and see more results would result in updated processing results being sent to the client computing device 102 corresponding to the additional results to be displayed. Illustratively, only returning processing results corresponding to a subset of the set of data being processed may allow the client computing device 102 to save memory or other computational resources by not having to manage a full set of data.

In one embodiment, a network computing provider 106 may provide processing results associated with a set of data including secure or private data. Illustratively, the secure or private data may be stored at the network computing provider 106 to prevent unauthorized dissemination or storage at an insecure client computing device 102. Illustratively, the processing results may correspond to a representation of non-sensitive aspects of the requested data only, and the network computing provider 106 may not send representations of the secure or private data, or may send a limited representation of the secure or private data.

As a specific example, in one embodiment, a processing result may include display data corresponding to an interface or application content associated with the application 122. For example, the NCC POP 138 may process process data in a parallel instance of the application running in a remote session, and may generate processing results including the displayed content or interfaces of the parallel instance of the application to send to the client computing device 102 via a communications protocol such as a remote desktop protocol (RDP). In one embodiment, the NCC POP 138 may send an RDP processing result corresponding to the layout and display of interfaces and content in the application. In another embodiment, the NCC POP 138 may send an RDP processing result including any displayed application content only, without any of the interface elements associated with the application. Illustratively, including an RDP processing result corresponding to displayed application content only may allow the application at the client computing instance 102 to display the content by assembling the RDP processing result in a content display area of the application without any further processing.

The client computing device 102 may obtain processing results provided by the one or more remote sessions and may provide the processing results to the application 122 through a data translation service or component or other means. In one embodiment, the application 122 executing at the client computing device 102 may be specially written or configured for remote session processing, and may have one or more components to handle the processing, translation, and display of processing results associated with process data. For example, a graphics application written for remote session processing may have a component that accepts RDP processing results from the network computing provider 106 corresponding to representations of an image file and update a content display pane in the application 122 with the said representation of the image. In another embodiment, the application 122 executing at the client computing device 102 may not be written for remote session processing, and the client computing device 102 may obtain processing results for the application 122, process the processing results to extract information, and place the extracted information in appropriate memory locations, cache locations, registers, or storage locations associated with the application 122. From the perspective of the application 122, the processing results may thus appear to have been generated by a thread or other sub-process executing locally at the client computing device.

The client computing device 102 may further provide additional process data to the remote session at the network computing provider 106. In one embodiment, providing data to the network computing provider 106 may include providing data, references, etc. as discussed with reference to block 614 above. For example, in various embodiments, the client computing device 102 may provide data or references to data comprising files, user interaction data, operating system or logical object structures, variable data, binary or structured application data, or any other kind or format of data for processing at the remote session. Illustratively, one or more remote sessions may process this data and return processing results as described above.

The exchange of data and processing results may continue until the remote session at the network computing provider 106 ends, the application 122 is closed, or the connection between the network computing provider 106 and client computing device 102 is disturbed. The routine 600 ends at block 618.

FIG. 7 is a flow diagram illustrative of a new remote session routine 700 implemented by a network computing provider 106 of FIG. 1. New remote session routine 700 begins at block 702. At block 704, the network computing provider 106 obtains remote session configuration information from the client computing device 102. As described above with reference to FIG. 6, in one embodiment, the remote session configuration information may identify and/or describe one or more sub-processes of an application executing at the client computing device 102 for which remote sessions should be instantiated. Illustratively, the remote session configuration information may be accompanied by initial process data for processing by the remote sessions.

At block 706 the network computing provider 106 may select an associated NCC POP to instantiate a new remote session based on the remote session configuration information. As discussed above with reference to FIG. 1, a network computing provider 106 may include any number of NCC POPs distributed across any number of physical or logical locations. A network computing provider 106 may select an NCC POP to host a remote session based on any number of factors, including, but not limited to available NCC POP resources (e.g., available memory, processor load, network load, etc.), a financial cost of hosting the remote session at the NCC POP, the NCC POP location respective to a client computing device 102, an NCC POP cache status (e.g., whether an application instance, application data, or another resource is already stored in an NCC POP cache), etc.

In one embodiment, the network computing provider 106 may select a number of NCC POPs to host a remote session. For example, the network computing provider 106 may select two NCC POPs with different logical locations in the network. Each NCC POP may independently instantiate remote sessions on the behalf of the client computing device 102, and the client computing device 102 may accept data from the first NCC POP to return a processing result. Subsequent to being selected by the network computing provider 106, NCC POP 138 may obtain one or more aspects of remote session configuration information associated with the remote session to host, as well as any associated initial process data. In one embodiment, NCC POP 138 may have remote session configuration information forwarded to it by a component of network computing provider 106. In another embodiment, NCC POP 138 or client computing device 102 may receive connection information allowing the establishment of direct communication between NCC POP 138 and client computing device 102. Illustratively, NCC POP 138 may be provided with the remote session configuration information and/or initial process data originally provided to the network computing provider 106, may be provided with a subset of information (e.g., just information describing the particular sub-process of the application corresponding to the remote session request), or may be provided additional information not included in the original remote session configuration information.

At block 708, subsequent to the NCC POP 138 being selected, the network computing provider 106 may cause the NCC POP 138 to instantiate a new remote session. Illustratively, instantiating a new remote session may include loading a new virtual machine instance and/or application instance at the NCC POP 138, reserving or allocating device memory, storage or cache space, processor time, network bandwidth, or other computational or network resources for the new remote session. Illustratively, one or more characteristics of the new remote session may be based on information included in the remote session configuration information. For example, the remote session configuration information may include executable code and/or references to executable code, one or more objects or object models for processing by the executable code, a framework or an identification of a framework for data translation and/or processing, a client computing device type or application type, a device operating system, a device screen resolution or display area, application configuration information or settings, and/or any other information defining the processing, preferences, or capabilities of the application 122, an application sub-process, or the client computing device 102.

In one embodiment, the NCC POP 138 may instantiate an application instance with the same or similar capabilities as the application 122. Illustratively, maintaining a parallel application with the same or similar capabilities as the application 122 may allow the NCC POP 138 to process process data within the full context of the specific application 122 running on the particular client computing device 102. In a further embodiment, the NCC POP 138 may instantiate a virtual machine instance with the same or similar capabilities as the computing device 102. Illustratively, maintaining a virtual machine instance with the same or similar capabilities as the client computing device 102 may allow the NCC POP 138 to process process data according to the appropriate dimensions and layout for display on the particular client computing device 102.

In some embodiments, the NCC POP 138 may utilize an existing virtual machine instance and/or application or remote session instance in addition to, or as an alternative to, instating a new remote session. For example, subsequent to the NCC POP 138 being selected, the network computing provider 106 may cause the NCC POP 138 to associate an existing instance of a remote session (e.g., an existing remote session corresponding to a sub-process of the application 122, or an existing parallel instance of the application 122) and/or virtual machine instance, such as one or more instances previously instantiated at the NCC POP 138, with a remote session request within the remote session configuration information. Illustratively, an existing remote session and/or virtual machine instance may correspond to another remote session, such as a parallel application or other remote sub-routine, associated with the application and the client computing device 102 or user, or may be a previously instantiated remote session associated with a different client computing device, user, or application instance. In other embodiments, the NCC POP 138 may instantiate a new remote session or other application process in an existing virtual machine instance, or may combine the utilization of previously instantiated and newly instantiated software processes in any number of other ways. In still further embodiments, the network computing provider or NCC POP 138 may instantiate any number of new virtual machine instances and/or remote sessions (or make use of existing instantiated instances) based on a single sub-routine defined in remote session configuration information.

At block 710 the network computing provider 106 may process any initial process data provided in or subsequent to block 704 above. One of skill in the art will appreciate that, in various embodiments, the process data (e.g., file data, application or operating system objects, variable values, etc.) may correspond to raw binary data provided by the client computing device 102, compressed or encrypted data, data stored in a digital file locker or other network storage location or at a cache component associated with the network computing provider 106 or client computing device 102, etc. Illustratively, the network computing provider 106 may provide resource requests based on any references contained in the process data to one or more sources of content such as content providers, content delivery network (CDN) service providers, and caches.

Continuing with block 710, the network computing provider 106 may process the initial process data to generate processing results to provide to the client computing device 102. As discussed above, in one embodiment, the remote session at the NCC POP 138 may include executable code associated with a sub-process of the application. Illustratively, if the executable code corresponding to the remote session consists of less than all of the code of the application, the NCC POP 138 may instantiate an execution environment or test harness for the code to execute in. Illustratively, instantiating an execution environment may include loading one or more objects or variables into the memory of the virtual machine instance or device memory associated with the remote instance. For example, an NCC POP 138 instantiating a section of code corresponding to a sub-process for processing an image may load any variables that would be used by the sub-process, as well as loading the image file in memory, and may additionally initialize a special memory or storage location to capture the results of the code execution. From the perspective of the sub-process executing within the remote session, it may appear as though the code is executing normally within the application at the client computing device 102.

In one embodiment, the network computing provider 106 may further instantiate a remote session including a parallel application process sequentially or simultaneously with the application instance running at the client computing device 102. Illustratively, a parallel application may be loaded in remote sessions at any number of NCC POPs in addition to the application executing at the client computing device. Each remote session may instantiate the same or different aspects or extents of application code from any other remote session, and each remote session may utilize the same or a different communications protocol as any other remote session. Process data provided to the NCC POP 138 may include user interaction data from a user interacting with the instance of the application at the client computing device and any other system, application, or device events necessary to maintain the operation of the applications in parallel. Illustratively, maintaining parallel applications may allow execution and processing of application functionality at the NCC POP 138 without the requirement of a special execution environment or test harness for a fragment of executing code.

In one embodiment, sub-processes identified for remote execution by the remote process configuration information may be paused or unloaded at the parallel application instance executing at the client computing device 102 while executing normally at the NCC POP 138. Subsequent to the parallel application at the NCC POP 138 completing an aspect of the sub-process processing, processing results may be provided to the parallel application at the client computing device, and the parallel instances may proceed with parallel execution. In some embodiments, pausing or unloading a sub-process at the client computing device 102 and waiting for processing results from the NCC POP 138 may allow the client computing device 102 to avoid committing computational resources to processing at the client computing device 102. In a further embodiment, the parallel application instance at the client computing device 102 may perform the processing associated with the sub-process execution in parallel with the execution of the sub-process at a remote session on the NCC POP 138. Illustratively, the client computing device 102 may produce a set of results of the sub-process, as well as receive processing results corresponding to a result of the sub-process from the NCC POP 138. In various embodiments, the client may utilize this duplication of results to check the accuracy of a processing result, or may accept the first result to return (e.g., from the local sub-process, or from one of any number of NCC POPs executing remote sessions in parallel), and cancel further execution of the slower process. Illustratively, running processes in parallel and accepting the first result to return may ensure that the client computing device 102 is providing results to a user as fast as possible.

As discussed above with reference to FIG. 3, the remote session executing at the NCC POP 138 may obtain process data directly from a client computing device 102. In other embodiments, process data may be retrieved by the NCC POP 138 from a content provider, CDN, or cache in response to the remote session configuration information. Process data provided by the client computing device 102 may include all the data or content associated with a remote session or may supplement content existing in a cache of the NCC POP 138, retrieved from a content provider or CDN, or obtained from some other source. In one embodiment, an NCC POP 138 may obtain all requested content from a local cache, and may not obtain any unprocessed resources or content from the client computing device 102. Illustratively, the NCC POP 138 may obtain process data from the client computing device 102 each time processing is required, or may maintain a parallel set of application data and/or content for processing.

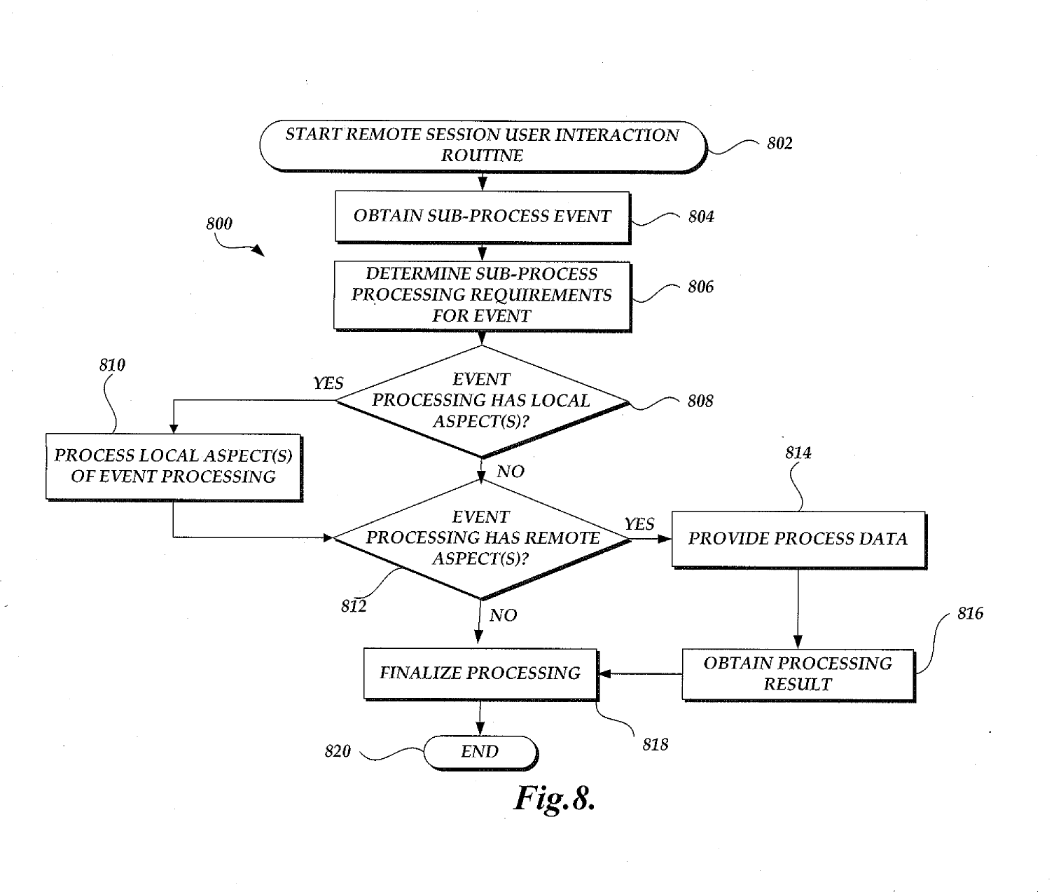

With continued reference to FIG. 7, at block 702, the network computing provider 106 may provide the initial processing result to the client computing device 102 for further processing and display. At block 714, the network computing provider may continue to exchange data and processing results with the client. For the purposes of further example, an illustrative remote session user interaction routine 800 implemented by client computing device 102 is described below with reference to FIG. 8. At block 716, the new remote session routine 700 ends.

Illustratively, in one embodiment, one or more aspects of the functionality described here as performed by a network computing provider 106 may be performed by any other computing device or set of computing devices. For example, in one embodiment, the functionality described here as performed by a network computing provider 106 may be performed by one or more computing devices, such as personal computers, tablets, smart phones, etc., associated with a user of the client computing device 102 or any other user or entity. In one embodiment, the one or more computing devices may be physically or logically local to the client computing device 102. The one or more computing devices may be linked by a wide area or local area network over wired or wireless connections or may be linked by any number of transmission mechanisms or communication protocols including Bluetooth, infrared, etc. For example, in one embodiment, a client computing device 102 such as a smart phone may provide remote session configuration information to a second computing device such as a nearby personal computer over Bluetooth. Based on the remote configuration information, the second computing device may instantiate one or more remote sessions corresponding to various sub-processes of an application running on the client computing device 102, and may return processing results to the client computing device 102 in the same manner as the network computing provider 106 discussed above. Illustratively, instantiating remote sessions on a local machine may allow many of the benefits of remote processing on a network computing provider 106 while only utilizing the processing power of local devices. In one embodiment, the client computing device 102 may provide first remote session configuration information to an alternate computing device to cause the alternate computing device to instantiate a first remote session corresponding to a first sub-process of an application 122, and may further provide second remote session configuration information to a network computing provider 106 to cause the network computing provider 106 to instantiate a second remote session corresponding to a second sub-process of the application 122. Illustratively, any number of alternate computing devices or network computing providers 106 may instantiate remote sessions associated with one or more sub-processes of an application 122 running at the client computing device 102.

In a still further embodiment, a client computing device 102 may specify in remote session configuration information that a local device such as a personal computer only instantiate a remote session for a particular sub-process of an application if certain conditions are true. If the conditions are not met, the local device may not instantiate the remote session and/or may pass remote session configuration information on to a network computing provider 106 to request that the network computing provider 106 instantiate the remote session instead or in addition. Illustratively, there may be any number of levels of redirection of remote session instantiation. For example, remote session configuration information may specify that a first local device instantiate a remote session if certain first conditions are met, and if not, that a second local device instantiate a remote session if certain second conditions are met, and if not, that a network computing provider 106 instantiate a remote session. In another embodiment, remote session configuration information may specify that a first network computing provider 106 instantiate a remote session, and if not, that a second network computing provider instantiate a remote session, etc. In still further embodiments, one or more devices or one or more network computing provider 106 may instantiate remote sessions in parallel. For example, the client computing device 102 may provide remote session configuration information to an alternate computing device and to a network computing provider 106. Illustratively, the remote session configuration information may cause both the alternate computing device and the network computing provider 106 to instantiate remote sessions associated with the same sub-process of the application 122. In one embodiment, both the alternate computing device 102 and the network computing provider 106 may process instructions associated with the sub-process, and may both provide processing results to the client computing device. The client computing device may accept the first processing result to be provided, or may accept a particular processing result based on a predefined or dynamically determined preference.

Although instructions to fall over (i.e., pass a request or information regarding the instantiation of a remote session for a sub-process of an application) to another device or network computing provider are described here as included in remote session configuration data generated by the client computing device 102, it should be understood that the decision to fall over to an alternate device or network computing provider 106 may be dynamically determined by any number of devices or network computing providers as discussed above, and instructions may be included or appended in remote session configuration information, or encoded and/or passed to other devices or network computing providers by any other means.

FIG. 8 is a flow diagram illustrative of a remote session user interaction routine 800 implemented by a client computing device 102. Remote session user interaction routine 800 begins at block 802. Illustratively, remote session user interaction routine 800 may begin subsequent to the instantiation of a new remote session at an NCC POP 138. For example, process user interaction routine 800 may correspond to block 714 of FIG. 7 above.

Illustratively, the application at the client computing device 102 may have one or more interactive elements, such as forms, buttons, animations, etc. User interaction with these interactive elements may require processing and display of data by one or more sub-processes. For example, selecting an element in a drop-down menu in an application may require processing and may change the configuration or visual appearance of the application. In other embodiments, processing may be required by any other system or application event or other trigger. For example, the completion of a data processing sub-process in the application may trigger the execution of a data formatting and display sub-process. Illustratively, and as discussed above with reference to FIGS. 6 and 7, processing may be handled locally at the client computing device 102 or as a remote session executing at the NCC POP 138, depending on the remote session configuration information. For example, if remote session configuration information specifies substantial local processing, various user interactions and other processing may be handled locally at the client computing device 102. Illustratively, handling user interactions locally at the client computing device 102 may, in some situations, allow for better responsiveness and fewer delays. For example simple user interactions (e.g., selection of a radio button, or typing text into a field), may execute quicker, as process data corresponding to the interaction does not need to be sent to the NCC POP 138 for processing.

As a further example, if the remote session configuration information specifies heavy remote processing of content, all user interactions with displayed content may be handled as remote user interactions at one or more remote sessions instantiated on various NCC POPs. For example, in one embodiment, as discussed above with reference to FIG. 7, an NCC POP 138 may be running a remote session including a parallel instance of the application 122 executing at the client computing device 102. Illustratively, user input (e.g., keyboard inputs and cursor positions) may be encapsulated in RDP protocol data units and transmitted across network 104 to the parallel application in the remote session at the NCC POP 138. Illustratively, the NCC POP 138 may apply the user interactions to the parallel application and transmit processing results consisting of updated bitmaps and interface data corresponding to an updated representation of the application and application content back to the client computing device 102. Illustratively, handling user interactions with an application remotely at the NCC POP 138 may have a negative impact on interface responsiveness, as data is required to pass over the network and is limited by network latency; however, processes that require a substantial amount of processing may perform better when handled as remote user interactions, as the processing latency of the NCC POP 138 may be substantially lower than the processing latency of the client computing device 102.

At block 804, the client computing device 102 obtains a sub-process event. Illustratively, the sub-process event may include any system or user interaction, application or system event or trigger, or other type of data causing the execution of one or more aspects of a sub-process of the application 122. This event may include an interaction with local interface components or content as described above, or may be an event generated by another sub-process of the application or operating system. Processing of this event by the sub-process may require local and/or remote processing depending on the nature of the component or element and the processing split specified by the remote session configuration information as described in FIGS. 6 and 7 and above. At block 806, the client computing device 102 determines the interaction processing requirements for the sub-process (e.g., based on the remote session configuration information.)

At decision block 808, if the sub-process should be processed entirely locally, or has any aspects that should be processed locally (e.g., simple interface feedback, preparation of process data to provide to the remote session, etc.) the routine 800 moves to block 810 to process the local aspect or aspects of the sub-process at the client computing device 102. Illustratively, and as discussed above, processing aspects such as updating interface components and other elements locally may allow an application to provide responsive user interfaces and content. Subsequent to processing any local aspect(s) of the sub-process, or if the sub-process has no local elements (e.g., an application utilizing an RDP communication protocol to receive and display bitmaps of result of processing) the routine 800 moves to decision block 812. If the sub-process should be processed entirely remotely, or has remote aspects that require processing, the routine 800 moves to block 814 and provides process data to the network computing provider 106. In one embodiment, in the case of heavily server side remote session configuration information, the process data may include user interaction data such as input data, a cursor position, or keyboard input (e.g., encapsulated in an RDP or similar protocol). In some embodiments, process data including remote user interaction data such as cursor positions may be provided to the network computing provider 106 on a continuous basis, while in other embodiments, process data including remote user interaction data may only be provided to the network computing provider 106 when associated with a specific event or sub-process execution.

At block 816, the client computing device 102 obtains an updated processing result from the network computing provider 106, the network computing provider 106 having processed any provided process data. At block 818, the client computing device 102 performs any additional processing required on the processing result and/or local processing performed in block 810 (e.g., based on the remote session configuration information). In one embodiment, this may include translating or preparing a processing result for integrating back into the flow of the application 122. At block 820 the process user interaction routine 800 ends. Illustratively, the routine may be executed again any number of times in response to further events triggering execution of one or more sub-processed of the application 122.

Illustratively, a remote session instantiated by the network computing provider 106 may terminate when an application or aspect of an application is closed or terminated, may terminate when a remote session is replaced by a sub-process executing at the client computing device 102 (e.g., if updated remote process configuration information specifies that a previously remote process should be performed locally), or may terminate in accordance with a timer or other event. Illustratively, the decision to terminate a remote session may be made by the client computing device 102, the network computing provider 106, the NCC POP 138, or any combination thereof. In one embodiment, if a remote session has terminated automatically due to a time-out but the application instance still persists at the client computing device 102 (e.g., if a user has stopped interacting with the application and no more process data has been sent to the remote session), later attempts by the user to interact with the content may cause a new remote session to be instantiated by the network computing provider 106 according to the last state of the terminated session. Illustratively, terminating a remote session after a time-out may allow the network computing storage provider 106 to save computing resources at the NCC POP. In one embodiment, this process may be transparent to the application 122 and/or user at client computing device 102, even though the remote session has been terminated during the intervening period.

In a further embodiment, the network computing provider 106 may maintain an application and/or system state associated with the application 122 even after the connection between the client computing device 102 and the network computing provider 106 has been lost (e.g., the application 122 has been terminated at the client computing device 102 or the client computing device 102 has lost network connectivity). Illustratively, launching a second instance of the application 122 at the client computing device 102 or reestablishing network connectivity may cause the application to connect to the network computing provider 106, obtain state data and/or processing results associated with the application's last state (which may herein be referred to as an “application context”), and resume local/remote execution from where it last left off. Illustratively, the retrieval of state data and/or processing results from the network computing provider may provide the user with an experience of seamless continuity from his earlier application session.

In a still further embodiment, the network computing provider 106 may continue to process data or execute instructions associated with the application 122 even after the connection between the application 122 running at the client computing device 102 and the network computing provider 106 has been lost. For example, a complex or resource intensive sub-process of an application 122 may be started at the network computing provider 106 by a user at a client computing device 102. For the purposes of this example, subsequent to starting the sub-process at the network computing provider 106, the user may power-down the client computing device 102, terminate the instance of the application 122 running at the client computing device 102, or lose network connectivity with the network computing provider 106. The network computing provider 106 may continue to perform processing associated with the sub-process even after the connection between the application 122 at the client computing device 102 and the network computing provider 106 is no longer active. In this example, when the user returns to use the application 122 at a subsequent point in time, the client computing device 102 may connect to the network computing provider 106 and obtain any processing results processed while the application 122 was not in communication with the network computing provider 106. The application 122 may perform any further processing and display these results for the user at the client computing device 102. Illustratively, processing results at the network computing provider 106 while not in communication with the client computing device 102 may allow a user at the client computing device 102 to start a computationally complex or intensive process and return at a later point to retrieve the results, without requiring that the client computing device 102 be continuously processing or running the application 122 or maintaining constant communication with the network computing provider 106.

In various other embodiments, multiple application contexts may be maintained at the network computing provider 106 corresponding to past states or terms of user interaction with an application. Accordingly, a particular application context may be selected by the user or client computing device 102 subsequent to an instance of the application being loaded in order to continue work from a past application context. For example, a user may be presented with graphical interfaces that facilitate the selection of one or more past states. Still further, in another embodiment, the user can create interactions from past application context that allows for parallel (or substantially parallel) branching.

While illustrative embodiments have been disclosed and discussed, one skilled in the relevant art will appreciate that additional or alternative embodiments may be implemented within the spirit and scope of the present invention. For example, the techniques described herein may be utilized, without departing from the scope of the present invention, to allow remote processing management in any number of other software applications and processes, including, but not limited to, image or video editing software, database software, office productivity software, 3d design software, audio and sound processing applications, etc. Additionally, although many embodiments have been indicated as illustrative, one skilled in the relevant art will appreciate that the illustrative embodiments do not need to be combined or implemented together. As such, some illustrative embodiments do not need to be utilized or implemented in accordance with the scope of variations to the present disclosure.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached FIGURES should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. It will further be appreciated that the data and/or components described above may be stored on a computer-readable medium and loaded into memory of the computing device using a drive mechanism associated with a computer readable medium, may be stored in any number of computer executable components such as a CD-ROM, DVD-ROM, or provided or obtained via a network interface; further, components and/or data can be included in a single device or distributed in any other manner. Accordingly, general purpose computing devices may be configured to implement the processes, algorithms, and methodology of the present disclosure with the processing and/or execution of the various data and/or components described above.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A computer-implemented method for remote execution management comprising:
initializing a software process instance;
obtaining software process configuration information associated with the software process instance, the software process configuration information identifying one or more sub-processes of the software process instance, wherein each of the one or more sub-processes of the software process instance comprises a plurality of executable instructions;
determining a remote process configuration for the software process instance based at least in part on the software process configuration information, wherein the remote process configuration identifies a sub-process of the one or more sub-processes of the software process instance for remote operation at a network computing provider, and wherein the remote process configuration identifies a communications protocol for the exchange of data;
providing process data to the network computing provider for processing in accordance with the communications protocol, wherein the process data includes a set of data associated with the software process instance and one or more executable instructions associated with the sub-process to be performed at the network computing provider;
obtaining one or more processing results from the network computing provider in accordance with the communications protocol, wherein the one or more processing results correspond to results of processing of the process data at the network computing and storage component, including execution of the one or more executable instructions; and
processing the obtained one or more processing results for use by the software process instance.

2. The computer-implemented method of claim 1, wherein the communications protocol includes at least one of Hypertext Transfer Protocol (HTTP), File Transfer Protocol (FTP), Remote Desktop Protocol (RDP), Virtual Network Computing (VNC) protocol, X-Windows protocol, and Remote Frame Buffer protocol.

3. The computer-implemented method of claim 1, wherein determining a remote process configuration for the software process instance includes determining a remote process configuration based on characteristics of data associated with the software process instance, a computational profile of the software process instance, a computational profile of a sub-process of the software process instance, a software process instance memory usage, a software process instance processor usage, a software process instance data store usage, a software process instance network usage, a characteristic of the client computing device, a characteristic of the network computing provider, a configuration of the client computing device, a current resource usage at the client computing device, a current resource usage at the network computing provider, a characteristic of a network connection, preferences associated with a user, or a predefined configuration.

4. A system for remote process execution comprising:
one or more computer processors;
at least one computer memory accessible by at least one of the one or more computer processors; and
a remote execution management component comprising an executable software module executed by the one or more computer processors, wherein the remote execution management component is operable to:
determine a remote process configuration for a software process instance, wherein the remote process configuration identifies at least one sub-process of the software process instance for remote operation;
provide process data associated with the at least one sub-process of the software process instance to a network computing provider, wherein the process data at least identifies at least one of data associated with the at least one sub-process of the software process instance and a plurality of instructions associated with the at least one sub-process of the software process instance;
obtain one or more processing results from the network computing provider, the one or more processing results associated with the execution of one or more of the plurality of instructions at the network computing provider; and
process the obtained one or more processing results in accordance with the software process instance.

5. The system of claim 4, wherein the remote process configuration identifies a communications protocol for exchange of data with the network computing and storage component.

6. The system of claim 5, wherein at least one of the process data and the one or more processing results are encoded in a format including at least one of text, Extensible Markup Language (XML), Hypertext Markup Language (HTML), JavaScript Object Notation (JSON), an executable binary, a compression format, an encrypted format, a software code format, an image format, a video format, and an audio format.

7. The system of claim 4, wherein the client computing device provides process data to the network computing provider and obtains one or more processing results from the network computing provider over a network connection.

8. The system of claim 7, wherein the network connection is intermittent.

9. The system of claim 4, wherein the at least one sub-process comprises a first sub-process and a second sub-process.

10. The system of claim 9, wherein the first sub-process is associated with a first communications protocol and the second sub-process is associated with a second communications protocol.

11. The system of claim 4, wherein the process data includes a set of data associated with the software process instance.

12. The system of claim 11, wherein the one or more processing results corresponds at least to a representation of the set of data associated with the software process instance.

13. The system of claim 12, wherein the remote execution management component is further operable to cause the display of the representation of the set of data.

14. The system of claim 13, wherein the representation of the set of data comprises less than all of the set of data.

15. The system of claim 4, wherein the remote execution management component is further operable to determine a remote process configuration for a software process instance based at least in part on software process execution data.

16. The system of claim 15, wherein the software process execution data is based on monitoring of execution of the software process instance.

17. The system of claim 16, wherein the software process execution data is based on monitoring of execution of one or more software processes related to the software process instance at one or more third-party computing devices.

18. The system of claim 15, wherein the remote execution management component is further operable to identify a sub-process of the software process instance for remote execution at the network computing provider based on the software process execution data.

19. The system of claim 15, wherein the remote execution management component is further operable to associate a communications protocol with a sub-process of the software process instance based on the software process execution data.

20. The system of claim 4, wherein the remote process configuration is based on information obtained from the network computing provider.

21. A computer-implemented method for remote process execution comprising:
initializing a software process instance;
determining a remote process configuration for the software process instance, wherein the remote process configuration identifies at least one sub-process of the software process instance;
providing process data to a network computing provider, wherein the process data identifies at least one of data associated with the at least one sub-process and a plurality of executable device instructions associated with the at least one sub-process;
obtaining one or more processing results from the network computing provider, wherein the one or more processing results are associated with execution of one or more of the plurality of executable device instructions associated with the at least one sub-process; and
processing the obtained one or more processing results in accordance with the software process instance.

22. The computer-implemented method of claim 21, wherein the client computing device provides process data to the network computing provider and obtains one or more processing results from the network computing provider over a network connection.

23. The computer-implemented method of claim 21, wherein the process data includes a set of data associated with the software process instance.

24. The computer-implemented method of claim 23, wherein the one or more processing results correspond at least to a representation of the set of data associated with the software process instance.

25. The computer-implemented method of claim 24, wherein processing the obtained one or more processing results in accordance with the software process instance includes causing the display of the representation of the set of data.

26. The computer-implemented method of claim 25, wherein the representation of the set of data comprises less than all of the set of data.

27. The computer-implemented method of claim 21 further comprising:
terminating the software process instance at the client computing device;
initializing a second software process instance at the client computing device; and
obtaining one or more processing results from the network computing provider, wherein the one or more processing results are associated with a last state of the software process instance prior to termination at the client computing device.

28. The computer-implemented method of claim 27, wherein obtaining one or more processing results from the network computing provider is based on limited network connectivity between the client computing device and a network computing provider.

29. The computer-implemented method of claim 27 further comprising, terminating the software process instance at the client computing device, wherein obtaining one or more processing results from the network computing provider includes obtaining one or more processing results prior to the termination of the software process instance.

30. The computer-implemented method of claim 21 further comprising providing second process data to a first computing device for processing, wherein the second process data identifies a second plurality of executable instructions associated with the at least one sub-process to be performed at the first computing device.

31. The computer-implemented method of claim 30 further comprising determining whether to provide processing data to the first computing device or the network computing provider based on a computing resource utilization associated with the computing device.
